(19) United States
(12) Patent Application Publication
(10) Pub. No.: US 2008/0303302 A1
(43) Pub. Date: Dec. 11, 2008

(54) Vehicle Console Assembly

(75) Inventors: Alan Sturt, West Bloomfield, MI (US); Gary Sadek, Troy, MI (US)

Correspondence Address: BROOKS KUSHMAN P.C.;INTL. AUTOMOTIVE COMPONENTS GROUP, 1000 TOWN CENTER, TWENTY-SECOND FLOOR, SOUTHFIELD, MI, 48075, US

(73) Assignee: LEAR CORPORATION, Southfield, MI (US)

(21) Appl. No.: 11/760,168

(22) Filed: Jun. 8, 2007

(51) Int. Cl. B60R 7/04

(52) U.S. Cl. 296/37.8

(57) ABSTRACT

A console assembly for use with a passenger seating area of a vehicle having a track configured for installment in the passenger seating area. At least one console receiving module is movably connected to the track and is in electrical communication with an electrical system of the vehicle. At least one console module having a housing defining a storage area therein releasably connected to the at least one console receiving module.

### BACKGROUND OF THE INVENTION

1. Field of the Invention

The present invention relates generally to a console assembly for use in a passenger seating area of a vehicle.

2. Background Art

Vehicle manufacturers continue to develop storage containers and devices for the passenger compartments of vehicles to accommodate occupant's personal items and automotive components. Several current storage containers are designed to fit within specified areas of the passenger compartment and allow limited access to items stored therein. Vehicles typically include any number of storage areas for storing items, such as but not limited to map pockets, seat pockets, overhead compartments, center consoles, etc.

Many automotive vehicles include a center console or other storage device disposed between passenger seats in the front passenger compartment of the vehicle. Typically, the center console is disposed between the driver and passenger seats in a forward seating area of the vehicle. However, it is common in larger vehicles, such as sport utility vehicles and vans, to provide center consoles between the second and/or third row passenger seating areas. Many of these consoles are affixed within the vehicle such that they are not easily moveable from one location to the next. Some vehicle layouts, such as but not limited to those associated with multiple rows of seating, may be suitable for use with moveable consoles.

### BRIEF DESCRIPTION OF THE DRAWINGS

The present invention is pointed out with particularity in the appended claims. However, other features of the present invention will become more apparent and the present invention will be best understood by referring to the following detailed description in conjunction with the accompany drawings in which:

FIG. 1 illustrates a perspective view of console assembly disposed within a vehicle having multiple rows of seating in accordance with one non-limiting aspect of the present invention;

FIG. 2 illustrates a side plan view of a console assembly in accordance with one non-limiting aspect of the present invention;

FIG. 3 illustrates a perspective view of a track and one or more console receiving modules of the console assembly;

FIG. 4 illustrates a perspective view of a track and pair of console receiving modules of the console assembly;

FIG. 5 illustrates a perspective view of the console housing mounted to the console receiving module in the vehicle;

FIGS. 6a-6b illustrate a more detailed view of a locking mechanisms in a locked position in accordance with one non-limiting aspect of the present invention; and

FIGS. 7a-7b illustrate a more detailed view of the locking mechanism in an unlocked position in accordance with one non-limiting aspect of the present invention.

### DETAILED DESCRIPTION OF THE PREFERRED EMBODIMENT(S)

Referring now to the Figures, a console assembly for use in the passenger seating area of a motor vehicle in accordance with the present invention is disclosed. It is understood that the console assembly may be used in either the front or rear passenger seating areas. For purposes of this disclosure, the console assembly will be installed in a rear passenger seating area between a pair of passenger seats.

In the following description, various operating parameters and components are described for a number of constructed embodiments. These specific parameters and components are included as examples and are not meant to be limiting. More specifically, directional language such as “left”, “right”, “above”, “below”, “upper”, “lower” and words of similar import designate directions shown in the drawings. Such directional terminology is used for clarity and is not intended to strictly limit the orientation of any aspect of the invention to a particular plane or direction.

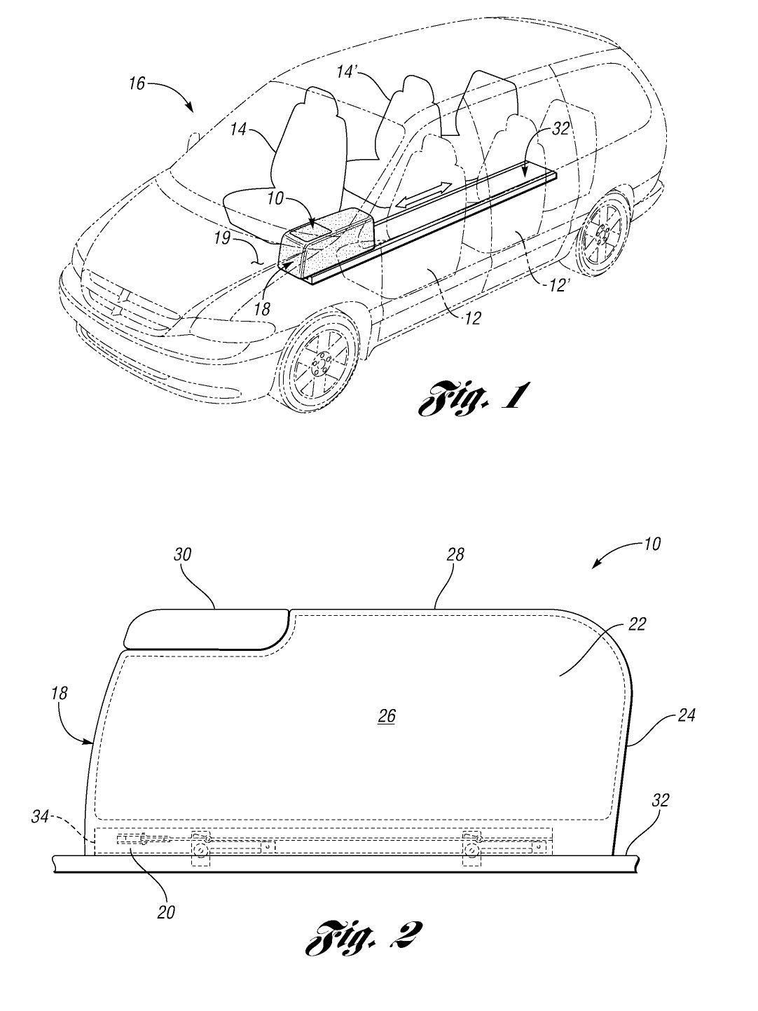

Referring now to Figures, a console assembly 10 is disposed between a pair of passenger seats 12, 14 in the passenger compartment of the vehicle 16. Passenger seats 12, 14 are shown to include bucket seats. FIG. 1 illustrates a vehicle 16 having multiple rows of seating 12, 14, 12′, 14′ in accordance with one non-limiting aspect of the present invention. The illustrated vehicle 16 is shown for exemplary purposes as a minivan and without intending to limit the scope and contemplation of the present invention. The present invention fully contemplates its use in any number of vehicles, including but not limited to other automobiles, watercraft, or aircraft. Further, the present invention contemplates the use of any number and type of seats, including bench seats, and is not intended to be limited to the non-limiting aspect of the present invention shown in the Figures.

Console assembly 10 may include a console module having a housing 18 disposed adjacent the floor 19 of the passenger compartment of the vehicle 16 configured for storing items therein. It is understood that the console module may be configured in a variety of geometries and configurations to be disposed on and secured to the floor of the passenger compartment of the vehicle or other support structure.

Console housing 18 generally includes a lower surface 20, front and rear surfaces, a pair of opposing side surfaces 22, 24 extending upward from the lower surface 20 all cooperating to form an internal cavity. It is understood that the console housing may be configured to include a variety of storage compartments or areas, such as storage bins or cup holders, formed on an external portion of the console housing. The internal cavity may include a storage area 26 generally accessible through a top surface 28 of the console housing 18.

A cover 30 may be adjustably positioned relative to the top surface 28 of the console housing 18. Cover 30 may be configured to act as an armrest which is positionable between a stowed position disposed at least partially adjacent the top surface 28 of the console module and a deployed position. The storage area 26 is generally configured to receive and store a variety of personal items, including mobile telephones, sunglasses, purses, bags or the like. Storage area 26 may also be configured to receive electronic components or other passenger convenience devices. The console housing 18 is shown for exemplary purposes only and may include any number of other features for storing items, both inside and outside of the illustrated cavity and cover.

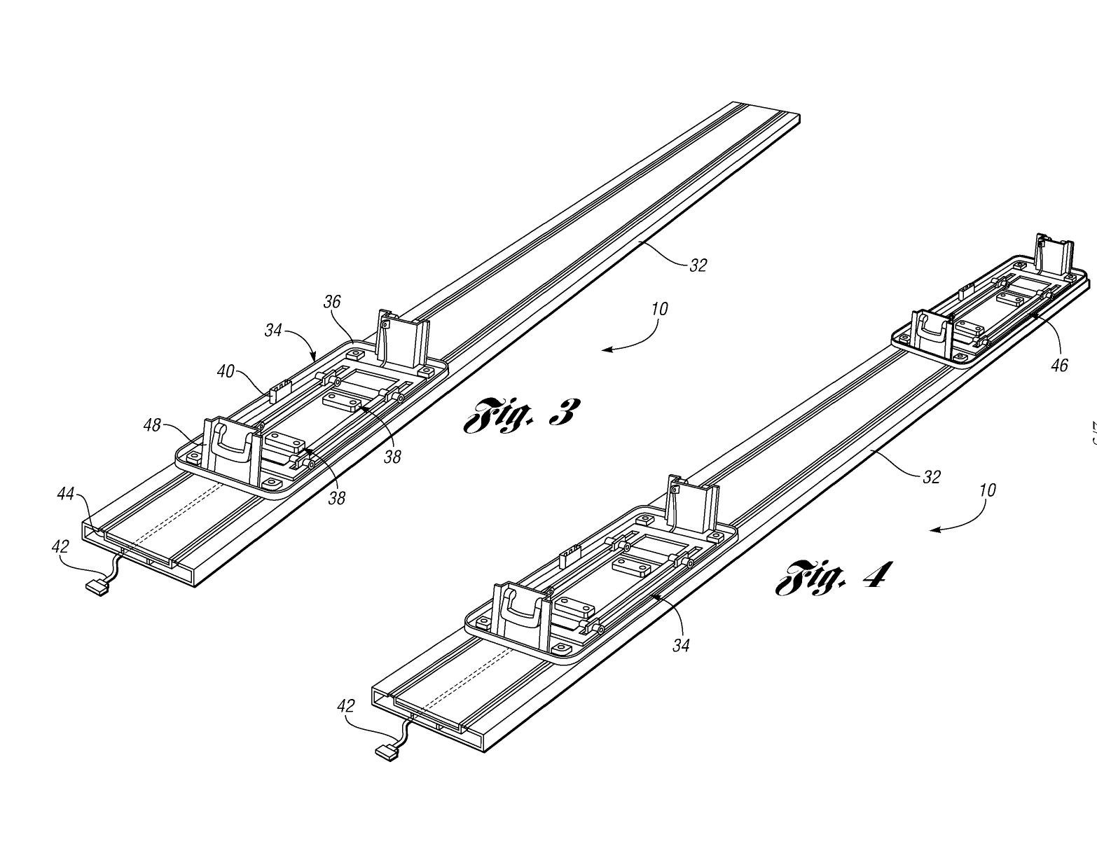

As illustrated in FIGS. 1 and 2, console assembly 10 may include a track 32 that extends between multiple rows of seats 12, 14, 12′, 14′. As described below in more detail, the console housing 18 may be affixed to the track 32 and adjustably positioned relative to seats 12, 14, 12′, 14′ to be easily accessed by multiple rows of passengers. FIGS. 1-4 best illustrate the track 32 configured for use in the passenger compartment of the vehicle. Track 32 may be formed as a unitary structure or as a series of interconnectable and cooperating structures. The track may be formed using a variety of manufacturing methods and materials, such as extruded aluminum, die molded composites and the like. The track may include one or more rails configured to receive the console housing module of the console assembly.

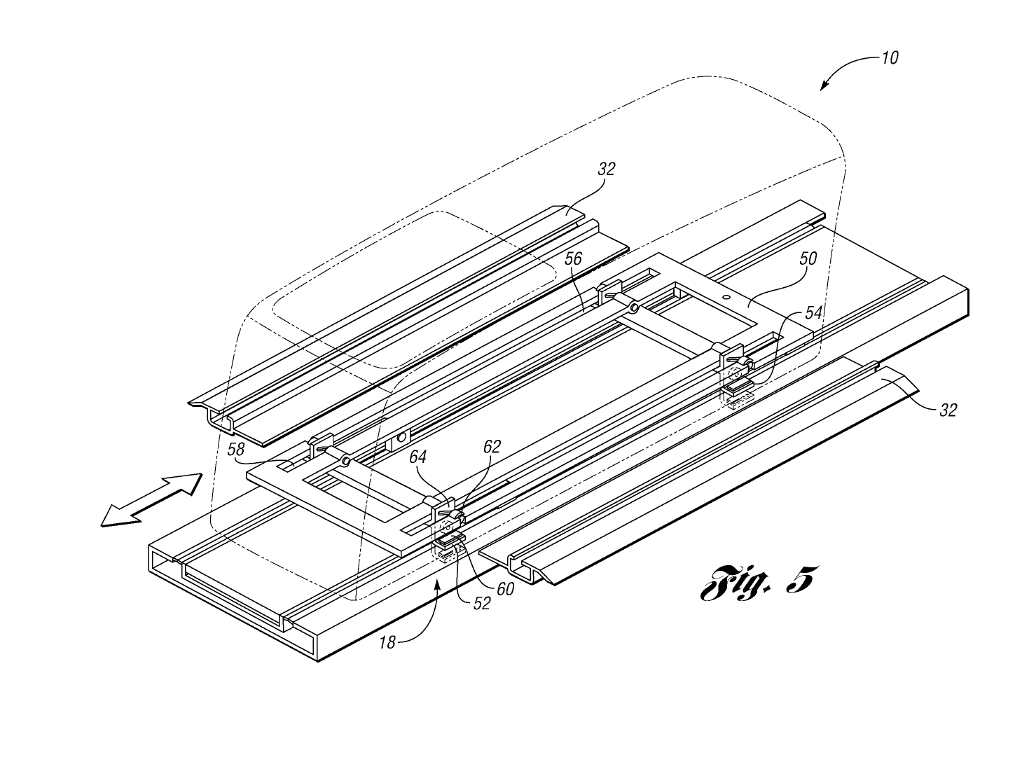

As shown in FIGS. 3 and 4, one or more console receiving modules 34 are disposed adjacent to track 32 to engage and move along track 32. The one or console receiving modules 34 are configured to receive and releasably secure console housing. The console receiving module mounting arrangement allows a variety of console housing modules to be attached thereto to suit a variety of manufacturer and consumer preferences.

Console receiving module 34 may include a base 36 having at least one attachment portion 38 for aligning and securing the console housing. In one non-limiting aspect of the present invention, a connector 40 may be provided on base 36 of the console receiving module. Connector 40 is in electrical communication with electrical conduit or harness 42 connected to the vehicle's electrical system. Connector 40 may engage a corresponding connector on the console module to provide electrical power to one or more components provided thereon.

Conduit 42 may move with the console receiving module 34 as the module 34 translates along track 32. Alternatively, the conduit may connect to electrically conductive strips provided on the track that are in electrical communication with mating portions on the console receiving modules. Conduit 42 may extend through a channel or protective cover 44 provided in an opening between the rails of the track 32. Referring to FIG. 4, a second console receiving modules 46 may be provided on the track 32 with the first console receiving module 34 to allow multiple console modules to be provided in the passenger compartment of the vehicle. Each console receiving module 34, 46 may be provided with an electrical conduit 42. Alternatively, a single conduit may provide power to the console receiving modules 34, 46.

As previously discussed, the console assembly 10 may include a console module that moves along track 32 which extends between multiple rows of seats. As described below in more detail, the console module housing 18 may be affixed to console receiving module 34 on the track 32 and moved back and forth between the various rows of seats. This allows the present invention to provide a moveable console module that may be easily accessed by multiple rows of passengers. It is also understood that the track assembly 32, electrical conduit or wiring harness 42, and console receiving modules 34, 46 may be installed independently in the vehicle passenger compartment or preassembled as a unit as a module for installation as a unit in the passenger compartment, thereby providing efficiency in the vehicle assembly process.

Optionally, the console module may be moved between the rows without requiring its removal from the tracks. This may be advantageous in facilitating movement of the console module as the operator is not required to lift the console module and replace it elsewhere in the vehicle while also allowing the console module to be easily shift from one location to another. In the event of a vehicle impact, the console module also may be restrained by the track 32 such that it is unable to become a dangerous flying object.

The track 32 may include a relatively low profile and/or be recessed with the vehicle floor. This may allow the console module to appear as if it moved within the flooring or carpeting associated with the same. The track may further include an overhanging element or other moveable element extending across the topside thereof so as to facilitate hiding the track openings. These elements may be moveable in response to movement of the console module.

The console module may be installed or otherwise loaded on the console receiving module 34 on the track by securing the module 18 to the at least one attachment portion 38. It is contemplated that the console module housing 18 may be removed from the console receiving module 34 using a release handle or locking mechanism 48 without disassembly of the console housing 18. Alternatively, one or more fasteners securing the console module housing 18 to the attachment portions 38 on console receiving module 34.

FIGS. 2 and 5 illustrate the console assembly 10 in accordance with one non-limiting aspect of the present invention. The console assembly 10 may include a locking mechanism 48 to facilitate securing the console housing 18 relative to the console receiving module 34, and thus, the console receiving module 34 to the track 32. The locking mechanism 48 generally includes four clamps 52-58 operating to apply pressure to an underside of the track 32. The locking mechanism 48 may be connected to a shuttle plate 50 configured for mounting on the console receiving module 34 such that the shuttle plate 50 and console receiving module 34 are free to move laterally within the console housing 18 in a forward and rearward direction relative to the illustration.

The pressure between the clamps 52-58 and track 32 may be sufficient to generate a friction brake between the track 32 and console housing 18 to prevent or substantially prevent movement of the console housing 18 under most operating conditions. During accidents or other high force impacts, the frictional force may be overcome and the console housing 18 moved along the track 32. This may be helpful to in preventing injuries or other damage to the element contacting the console housing 18.

In another non-limiting aspect of the present invention, forward and rearward springs may attach relative to lateral ends of the shuttle plate and corresponding ends of the console receiving module to bias the shuttle plate to a position suitable for locking the locking mechanism. The forward spring may be a scissor type spring having a cable connecting to a handle on the console receiving module. In this manner, the forward movement of the shuttle plate unlocks the locking mechanism so that the console receiving module may be easily moved within the track and the rearward movement locks the locking mechanism to secure the console receiving module relative to the track.

A scissor spring may be biased to move from the closed position to the open position such that the scissor spring cooperates with the rearward spring to pull the forwardly positioned shuttle plate rearwardly to the locked position. Once so position, the locking mechanism is again locked to secure position of the console receiving module within the track. This allows the present invention to facilitate movement of the console receiving module along the track, and optionally between the different rows of seats, by pulling and releasing the handle.

The present invention fully contemplates the use of any number of mechanical, electrical, and/or electro-mechanical items and features to facilitate moving the shuttle plate individually or collectively locking and unlocking the lever clamps. Furthermore, the present invention fully contemplates a lock, restraint, or other feature to hold the shuttle plate in the unlocked position so as to permit the console receiving module to be moved to another location along the track without requiring constant manual retraction of the shuttle plate.

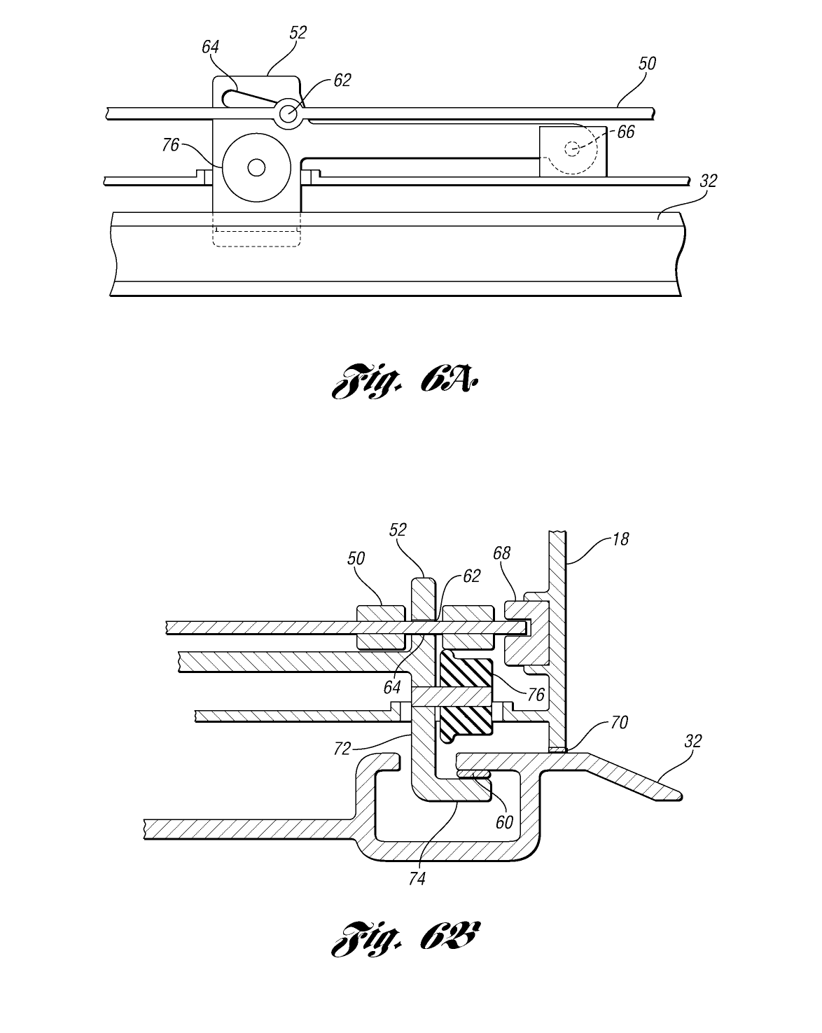

FIGS. 6a-6b illustrate a more detailed view of one clamp 52 of the locking mechanism 48 in a locked position in accordance with one non-limiting aspect of the present invention. The lever clamp 52 is shown in the locked position such that a pad 44 attached to the topside is pressed against the underside of the track 32. The forced applied to the underside of the track 32 is preferably sufficient to secure positioning of the console housing 18 relative to the track 32.

The spring forces applied to the shuttle plate 50 may be used to bias the lever clamp 52 against the underside of the track 32. The shuttle plate may include a pin 62 configured to engage an angled ramp 48 at the topside of the lever clamp 52. The ramp 48 may be angled such that the rearward movement of the shuttle plate 50 cause the lever clamp 52 to travel to a bottom portion of the ramp 48, thereby causing the lever clamp to engage the bottom side of the track 32.

One end of the lever clamp 52 may be journaled in a pivot 66 attached to the console housing 18 such that it is free to rotate with movement of the shuttle plate 50. This configuration allows the locking mechanism 48 components to be secured to the console housing 18 such that only the shuttle plate 50 moves laterally within the console housing 18 to cause the lever clamp 52 to move vertically. As shown in FIG. 6b, the console housing 18 may include a guide block 68 to guide the moving shuttle plate 50.

The sides of the console housing 18 may rest against the topside of the track 32. This may help restrain movement of the console housing 18 relative to the track 32. Friction pads 70 may be optionally attached to the bottom sides of the console housing 18 so as to further facilitate the frictional connection to the track 32. The flush mounting and extension of the lever clamp 52 within the underside of the track 32 may facilitate aesthetic appeal by concealing the locking mechanism from view. If carpet or other material overlays the track, the console housing 18 may abut the covering and present the illusion that it is permanently affixed to the flooring.

The lever clamp 52 may include a vertically extending portion 72 and a laterally extending portion 74. The friction pad 60 may be attached to the laterally extending portion 74 and positioned under the track 32 with the vertically extending portion 72 such that the pad 60 extend under the underside of the track 32. The track 32 may include a c-shaped portion configured to receive the laterally extending portion 72 so as to facilitate the pad 60 contacting the underside of the track 32. This arrangement may also be helpful in securing the console housing 18 within the track 32, which can be helpful in preventing the console housing 18 from tipping over or otherwise being removed from the track 32.

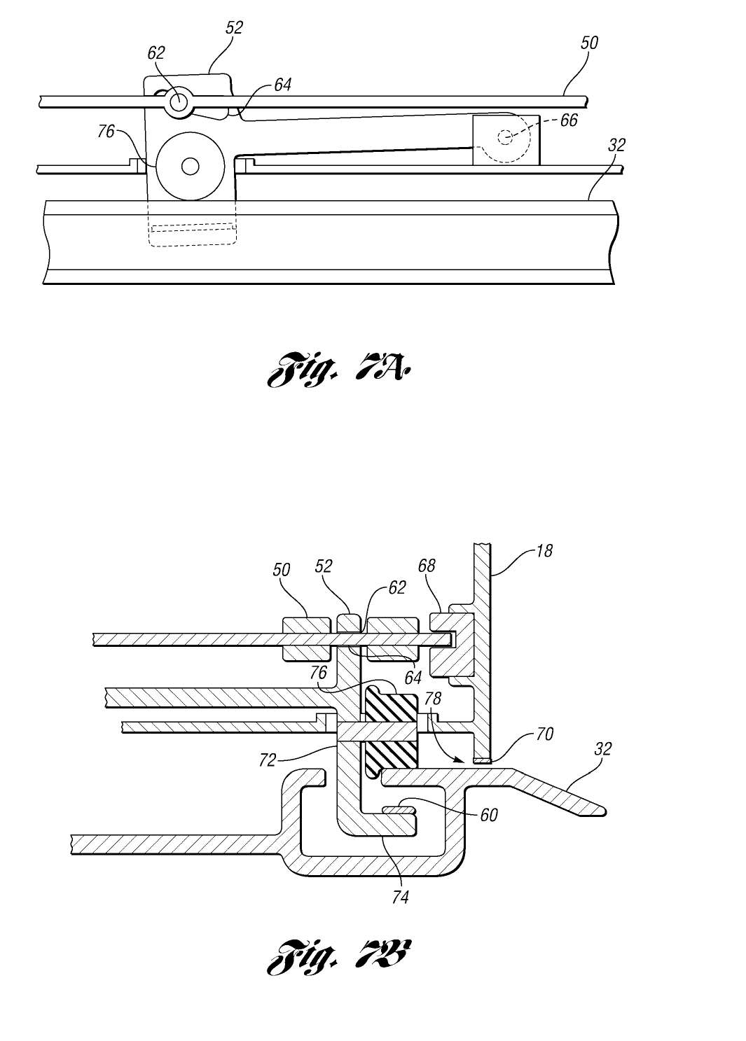

FIGS. 7a-7b illustrate a more detailed view of one clamp 52 of the locking mechanism 48 in an unlocked position in accordance with one non-limiting aspect of the present invention. The unlocked position generally corresponds with the clamp 52 dropping below the underside of the track 32 such that all or substantially all of the friction between the friction pad 60 and track 32 is removed, thereby permitting the console housing 18 to freely moved within the track 32.

The spring forces associated with the forward and rearward springs 34-36 may be surpassed in order to move the shuttle plate 50 leftwardly. The leftward movement of the shuttle plate 50 causes the shuttle pin 62 to travel within the lever clamp ramp 64 in such a manner as to force the lever clamp 52 to rotate in a downward direction, thereby dropping the friction pad 60 below the underside of the track 32.

The lever clamp 52 may further include a roller 76 configured to contact a top side of the track 32 with actuation of the shuttle plate 50. The roller 76 may be configured to roll along the topside of the track 32 so as to facilitate movement of the console housing 18. The shuttle ramp 64 and leftward movement of the shuttle plate 50 may be sufficient to press the roller 64 against the topside of the track 32 such that the roller 76 raises the console housing 18 to create a gap 78 between the bottom side of the console housing 18 and the topside of track 32. This may be helpful in facilitating movement of the console housing 18.

The foregoing is only one exemplary configuration for instigating the vertical movements of the lever clamp 52 and console housing 18. The present invention is not intended to be limited to this particular embodiment and fully contemplates the use of any number of other features to facilitate such movement. For example, the shuttle plate may be connect to the lever clamp by way of a cam, crank arm, or other feature suitable to actuated the lever clamp in the manner described above and without necessarily requiring movement of a pin or other element within the ramp.

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a representative basis for the claims and/or as a representative basis for teaching one skilled in the art to variously employ the present invention.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A console assembly for use with a passenger seating area of a vehicle, the console assembly comprising:
a track configured for installment in the passenger seating area;
at least one console receiving module movably connected to the track; and
at least one console module having a housing defining a storage area therein releasably connected to the at least one console receiving module,
wherein the at least one receiving module is in electrical communication with an electrical system of the vehicle.

2. The console assembly of claim 1 wherein the housing of the at least one console module further comprises a lower surface configured for mounting on the at least one console receiving module, a front surface, a rear surface and a pair of opposing side surfaces each extending upward from the base and cooperating with each other to form the storage area therebetween.

3. The console assembly of claim 2 wherein the housing of the at least one console module further comprises a cover connected to the housing adjustably positionable between a stowed position disposed at least partially adjacent a top surface of the housing and a deployed position, wherein an opening in the top surface of the housing is exposed to allow access to the storage area.

4. The console assembly of claim 1 wherein the at least one console receiving module further comprises a single console receiving module movably connected to the track.

5. The console assembly of claim 1 wherein the at least one console receiving module further comprises first and second console receiving modules movably connected to the track.

6. The console assembly of claim 1 wherein the at least one console receiving module further comprises an electrical connector in communication with the vehicle electrical system through an electrical conduit to provide electrical power to a cooperating connector in the at least one console module.

7. The console assembly of claim 1 wherein the at least one console receiving module further comprises one or more clamps proximate a bottom side of the receiving module, the one or more clamps including a locked and unlocked position, the locked position corresponding with the one or more clamps pressing against the track to create a friction brake sufficient to secure positioning of the console receiving module with respect to the track, the unlocked position corresponding with removal of the friction brake such that the console receiving module is free to move relative to the track.

8. The console assembly of claim 7 wherein the one or more clamps further comprises a clamp provided at each of the four distal ends of the console receiving module to generate friction brakes with the track.

9. The console assembly of claim 1 further comprising a release mechanism configured to releasably connect the console module housing to the console receiving module.

10. A console assembly for use with a passenger seating area of a vehicle, the console assembly comprising:
a track configured for installment in the passenger seating area;
a console receiving module movably connected to the track; and
a console module having a housing defining a storage area therein releasably connected to the console receiving module,
wherein the console receiving module further comprises an electrical connector in communication with an electrical system of the vehicle through an electrical conduit to provide electrical power to a cooperating connector in the console module housing.

11. The console assembly of claim 10 wherein the housing of the at least one console module further comprises a lower surface configured for mounting on the at least one console receiving module, a front surface, a rear surface and a pair of opposing side surfaces each extending upward from the base and cooperating with each other to form the storage area therebetween.

12. The console assembly of claim 11 wherein the housing of the at least one console module further comprises a cover connected to the housing adjustably positionable between a stowed position disposed at least partially adjacent a top surface of the housing and a deployed position, wherein an opening in the top surface of the housing is exposed to allow access to the storage area.

13. The console assembly of claim 10 wherein the track further comprises a pair of rails formed of extruded aluminum secured to a floor of the vehicle.

14. The console assembly of claim 10 wherein the at least one console receiving module further comprises one or more clamps proximate a bottom side of the receiving module, the one or more clamps including a locked and unlocked position, the locked position corresponding with the one or more clamps pressing against the track to create a friction brake sufficient to secure positioning of the console receiving module with respect to the track, the unlocked position corresponding with removal of the friction brake such that the console receiving module is free to move relative to the track.

15. The console assembly of claim 14 wherein the one or more clamps further comprises a clamp provided at each of the four distal ends of the console receiving module to generate friction brakes with the track.

16. The console assembly of claim 10 further comprising a release mechanism configured to releasably connect the console module housing to the console receiving module.

17. The console assembly of claim 10 wherein the electrical conduit is connected to conductive elements on the track that supply electrical power to corresponding electrically conductive elements on the console receiving module.

18. A console assembly for use with a passenger seating area of a vehicle, the console assembly comprising:
a track having a pair of rails formed of extruded aluminum secured to a floor of the passenger seating area of the vehicle;
at least one console receiving module movably connected to the track;
at least one console module having a housing defining a storage area therein releasably connected to the at least one console receiving module; and
an electrical connector provided on the at least one console receiving module in communication with an electrical system of the vehicle through an electrical conduit to provide electrical power to a cooperating connector in the console module housing,
wherein the console receiving module further comprises one or more clamps proximate a bottom side of the receiving module, the one or more clamps including a locked and unlocked position, the locked position corresponding with the one or more clamps pressing against the track to create a friction brake sufficient to secure positioning of the console receiving module with respect to the track, the unlocked position corresponding with removal of the friction brake such that the console receiving module is free to move relative to the track.

19. The console assembly of claim 18 wherein the at least one console receiving module further comprises a single console receiving module movably connected to the track.

20. The console assembly of claim 18 wherein the at least one console receiving module further comprises first and second console receiving modules movably connected to the track.
